(19) United States
(12) Patent Application Publication
(10) Pub. No.: US 2024/0402754 A1
(43) Pub. Date: Dec. 5, 2024

(54) METHOD FOR CLOCK COMPENSATION IN COMMUNICATION DEVICE AND RELATED COMMUNICATION DEVICE

(71) Applicant: Realtek Semiconductor Corp., HsinChu (TW)

(72) Inventors: I-Hsueh Lin, HsinChu (TW); Pen-Ao Chen, HsinChu (TW)

(73) Assignee: Realtek Semiconductor Corp., HsinChu (TW)

(21) Appl. No.: 18/415,595

(22) Filed: Jan. 17, 2024

(30) Foreign Application Priority Data
May 31, 2023 (TW) 112120266

(51) Int. Cl. G06F 1/12

(52) U.S. Cl. CPC G06F 1/12

(57) ABSTRACT

A method for performing clock compensation in a communication device includes: determining a clock difference between a source operating clock and a target operating clock; performing clock compensation according to the clock difference, thereby obtaining a compensated time; and according to the compensated time, performing a clock synchronization process based on precision time protocol.

### BACKGROUND OF THE INVENTION

### 1. Field of the Invention

The present invention relates to communication, particularly to a method and a related communication device for clock compensation in processing of a communication device under Precision Time Protocol.

### 2. Description of the Prior Art

Precision Time Protocol (PTP) is a protocol employed for synchronizing clocks of different nodes in a communication system, thereby to cater to application scenarios requiring high-precision clock synchronization. Under PTP protocol, nodes interact with each other through PTP messages containing timestamps, such as Sync, Follow_Up, Delay_Req and Delay_Resp. By exchanging these messages between nodes, a receiving end can calibrate its clock to alleviate the impact of transmission delays and synchronize with the clock of a transmitting end.

Generally, a circuit responsible for processing PTP (e.g., a PTP processing circuit), which is disposed between Medium Access Control (MAC) layer and Physical (PHY) layer, is tasked with adding timestamps into packets (at the transmitting end), or correcting time based on timestamps extracted from received packets (at the receiving end). In terms of hardware implementation, the MAC layer and the PHY layer have their respective operating clocks (i.e., reference clock signals). The inconsistency between the operating clocks used by the MAC layer and the PHY layer may lead to additionally uncertain errors when the PTP processing circuit adds timestamps into the packets, such that the accuracy of PTP is degraded. However, having the MAC layer and PHY layer use the same operating clock would require significant modifications to the entire circuit architecture, making implementation quite complex and difficult. Therefore, there is a need in the art for a method capable of improving the accuracy of PTP.

### SUMMARY OF THE INVENTION

In light of above, it is one object of the present invention to provide a mechanism for clock compensation in processing regarding PTP. Specifically, the present invention is achievable to correct errors caused by involvement of different operating clocks in a PTP processing circuit. In embodiments of the present invention, an adjusted operating clock is obtained by compensating an operating clock of a physical layer circuit, thereby to acquire a compensated time based on an operating clock of a media access control layer circuit. Alternatively, embodiments of the present invention obtains the compensated time based on the operating clock of the media access control layer circuit by performing time comparison and calibration at specific time points. In this way, the PTP processing circuit can carry out a clock synchronization process based on the compensated time, thereby obtaining more accurate time information and improving precision of the clock synchronization process.

According to one embodiment, a method for performing clock compensation in a communication device is provided. The method comprises: determining a clock difference between a source operating clock and a target operating clock; performing clock compensation according to the clock difference, thereby obtaining a compensated time; and performing a clock synchronization process based on a precision time protocol according to the compensated time.

According to one embodiment, a communication device is provided. The communication device comprises: a clock compensation circuit and a precision time protocol (PTP) processing circuit. The clock compensation circuit is configured to determine a clock difference between a source operating clock and a target operating clock and to perform clock compensation according to the clock difference to obtain a compensated time. The PTP processing circuit is coupled to the clock compensation circuit, and configured to perform a clock synchronization process based on PTP according to the compensated time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a communication device according to one embodiment of the present invention.

FIG. 2 illustrates how to generate a compensated time according to one embodiment of the present invention.

FIG. 3 illustrates a flow chart of a method for clock compensation on clock synchronization based on PTP according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

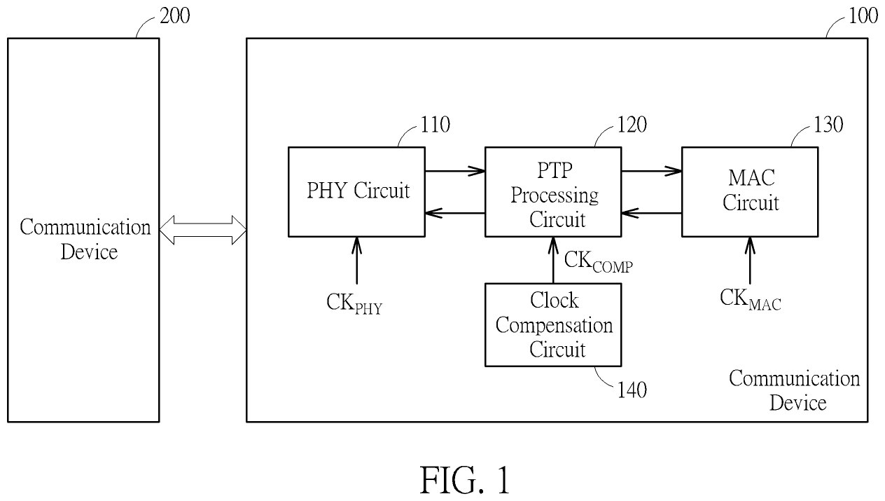

Please refer to FIG. 1, which illustrates a schematic diagram of a communication device according to one embodiment of the present invention. As shown in the figure, a communication device 100 exchanges information with a communication device 200 via a transmission channel. The communication device 100 can be either an information receiver end or an information transmitter. In one embodiment, the communication device 100 can be a communication device compatible with IEEE 802.3 protocol. The communication device 100 includes: a physical (PHY) layer circuit (i.e., PHY circuit) 110, a Precision Time Protocol (PTP) processing circuit 120, a Medium Access Control layer circuit (i.e., MAC circuit) 130 and a clock compensation circuit 140. The PHY circuit 110 is configured to perform operations and processing on data/signal/information related to the PHY layer. The PTP processing circuit 120 is configured to add timestamps and/or other PTP messages to data units (such as packets) transmitted between the MAC circuit 130 and the PHY circuit 110, or obtain timestamps and/or other PTP messages from data units to correct a local time/clock (i.e., a clock synchronization process). The MAC circuit 130 is configured to perform operations and processing on data/signal/information related to the MAC layer.

When the PHY circuit 110 performs operations and processing on data/signal/information related to the PHY layer, these operations and processing will be performed based on a reference operating clock CK_{PHY} (where the operating clock CK_{PHY} is a reference clock signal for the PHY circuit 110). In one embodiment, a frequency of the operating clock CK_{PHY} is 200 MHz. When the MAC circuit 130 performs operations and processing on data/signal/information related to the MAC layer, these operations and processing will be performed based on a reference operating clock CK_{MAC} (where the operating clock CK_{MAC} is a reference clock signal for the MAC circuit 130). In one embodiment, a frequency of the operating clock CK_{MAC} is 156.25 MHz. Typically, the clock compensation circuit 140 counts/calculates a local time based on the operating clock CK_{PHY} and performs the clock synchronization process accordingly. However, the operating clock CK_{PHY} is inconsistent with the operating clock CK_{MAC}of the MAC circuit 130. This may degrade the precision of the clock synchronization process. Since there is a clock difference between the operating clock CK_{PHY} and operating clock CK_{MAC}, the clock compensation circuit 140 processes the operating clock CK_{PHY} based on the clock difference and accordingly provides a compensated time to the PTP processing circuit 120. This allows the PTP processing circuit 120 to perform the clock synchronization process with more precise time information.

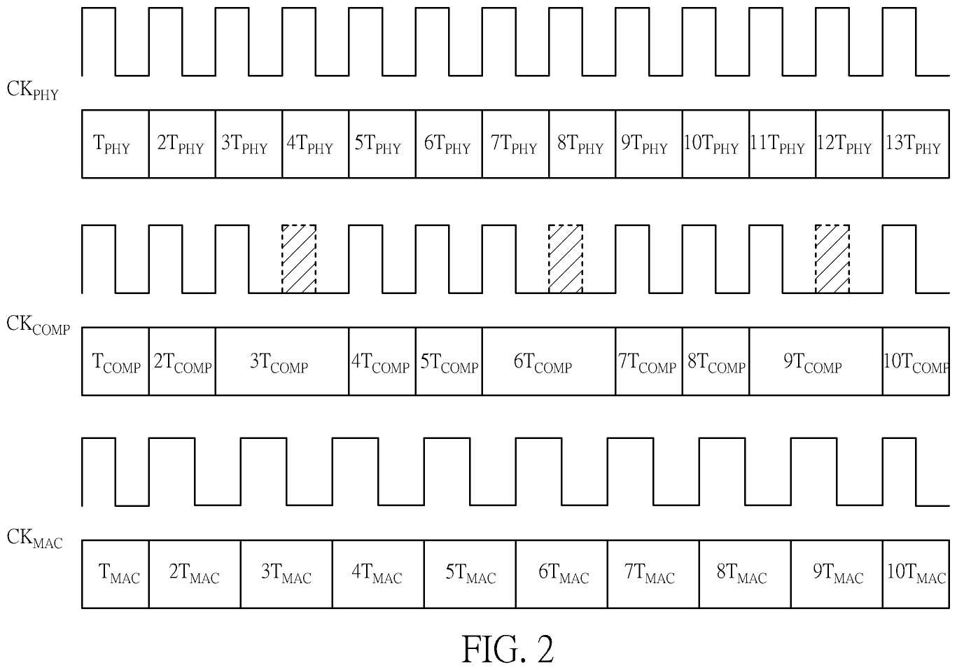

Please refer further to FIG. 2, which illustrates operation principles of the clock compensation circuit 140 according to one embodiment of the present invention. As shown by FIG. 2, the PHY circuit 110 of the communication device 100 uses the operating clock CK_{PHY} as a clock reference, and thus “13” rising edges of the operating clock CK_{PHY} would cause the PHY circuit 110 to count/calculate a time period of “13” time units T_{PHY} (i. e., 13T_{PHY}). The clock compensation circuit 140 is configured to calculate the clock difference based on the operating clocks CK_{PHY} and CK_{MAC}, and accordingly mask specific rising edges of the operating clock CK_{PHY} to obtain an adjusted operating clock CK_{COMP}. As shown by FIG. 2, the adjusted operating clock CK_{COMP} has only “10” rising edges within the time period of 13T_{PHY}. Therefore, the clock compensation circuit 140 counts/calculates the time based on the adjusted operating clock CK_{COMP}. The number of time units T_{COMP} is the compensated time. Each time one of rising edges of the adjusted operating clock CK_{COMP} is triggered, a time unit T_{COMP} is accumulated. The accumulated result of the number of the time units T_{COMP} is equivalent to the accumulated result of the number of the time units T_{MAC}. In other words, the compensated time calculated based on the adjusted operating clock CK_{COMP} is consistent with the 10 time units T_{MAC} calculated based on the operating clock CK_{MAC}. That is, the compensated time generated by the clock compensation circuit 140 is actually the time calculated based on the operating clock CK_{MAC}. In addition to the embodiment shown in FIG. 2, compensation can also be carried out by determining the regularity of different operating clocks. For example, rising edges of the operating clock CK_{PHY} and CK_{MAC} align after every “N” time units T_{PHY}. Then, the clock compensation circuit 140 can perform clock correction at the time that the operating clocks CK_{PHY} and CK_{MAC} align. Within the period of “N” time units T_{PHY} (i.e., the operating clocks CK_{PHY} and CK_{MAC} do not align), an internal timer of the clock compensation circuit 140 uses the operating clock CK_{PHY} to count time. Once the period of N time units T_{PHY} expires, clock correction is performed (by comparing the local time with an absolute time (as a reference)), thereby to obtain the compensated time.

Through the compensated time provided by the clock compensation circuit 140, the PTP processing circuit 120 is configured to add timestamps based on the compensated time into packets transmitted between the PHY circuit 110 and the MAC circuit 130, thereby achieving clock synchronization with the communication device 200.

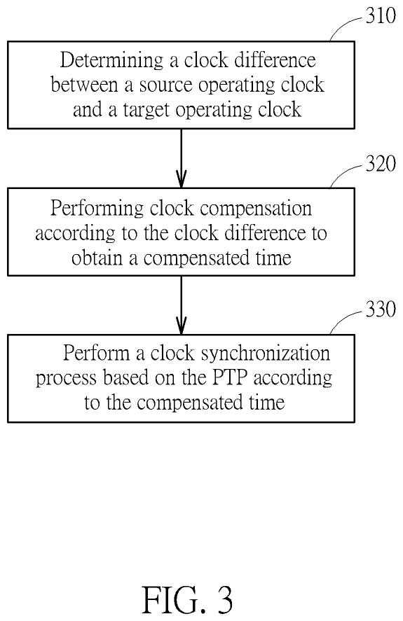

FIG. 3 illustrates a flow of a method for clock compensation on a clock synchronization process based on PTP. As shown in the figure, the method of the present invention includes the following simplified steps:
Step 310: determining a clock difference between a source operating clock and a target operating clock;
Step 320: performing clock compensation according to the clock difference to obtain a compensated time; and
Step 330: perform a clock synchronization process based on PTP according to the compensated time.

Since principles and details of the above steps have been detailed in the above embodiments, repeated descriptions are omitted here for sake of brevity. It is worth noting that the above process may involve adding other additional steps or making appropriate modifications and adjustments to better improve the efficiency and precision/accuracy of the clock synchronization process.

Embodiments in accordance with the present embodiments can be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing clock compensation in a communication device, comprising:
determining a clock difference between a source operating clock and a target operating clock;
performing clock compensation according to the clock difference, thereby obtaining a compensated time; and
performing a clock synchronization process based on a precision time protocol according to the compensated time.

2. The method of claim 1, wherein the source operating clock is an operating clock of a physical layer circuit of the communication device, and the target operating clock is an operating clock of a medium access control layer circuit.

3. The method of claim 1, wherein the step of performing clock compensation based on the clock difference to obtain the compensated time comprises:
based on the clock difference, masking specific rising edges of the source operating clock to obtain an adjusted operating clock; and
obtaining the compensated time based on the adjusted operating clock.

4. The method of claim 1, wherein the step of performing clock compensation based on the clock difference to obtain the compensated time comprises:
based on the clock difference, determining a time period representing an interval after which the source operation clock and the target operation clock align; and
upon expiration of the time period, performing a calibration process based on a local time and an absolute time to obtain the compensated time.

5. The method of claim 1, wherein the step of performing the clock synchronization process based on the precision time protocol according to the compensated time comprises:
adding a timestamp based on the compensated time into a packet between a physical layer circuit and a medium access control layer circuit of the communication device for the clock synchronization process.

6. A communication device, comprising:
a clock compensation circuit, configured to determine a clock difference between a source operating clock and a target operating clock and to perform clock compensation according to the clock difference to obtain a compensated time; and
a precision time protocol (PTP) processing circuit, coupled to the clock compensation circuit, configured to perform a clock synchronization process based on PTP according to the compensated time.

7. The communication device of claim 6, wherein the source operating clock is an operating clock of a physical layer circuit of the communication device, and the target operating clock is an operating clock of a medium access control layer circuit.

8. The communication device of claim 6, wherein the clock compensation circuit is configured to mask specific rising edges of the source operating clock based on the clock difference, thereby obtaining an adjusted operation clock, and the clock compensation circuit is further configured to obtain the compensated time based on the adjusted operating clock.

9. The communication device of claim 6, wherein the clock compensation circuit is configured to, based on the clock difference, determine a time period representing an interval after which the source operation clock and the target operation clock align; and upon expiration of the time period, the clock compensation circuit is configured to perform calibration based on a local time and an absolute time to obtain the compensated time.

10. The communication device of claim 6, wherein the PTP processing circuit is configured to add a timestamp based on the compensated time into a packet between a physical layer circuit and a media access control layer circuit of the communication device to perform the clock synchronization process.
